(19) United States
(12) Patent Application Publication
(10) Pub. No.: US 2008/0283312 A1
(43) Pub. Date: Nov. 20, 2008

(54) Motor Vehicle Comprising an Electric Energy Source and a Method for Operation Said Vehicle

(75) Inventors: Peter Birke, Gliencke/Nordbahn (DE); Michael Keller, Baden-Baden (DE)

Correspondence Address: CONTINENTAL TEVES, INC., ONE CONTINENTAL DRIVE, AUBURN HILLLS, MI, 48326-1581, US

(73) Assignee: Temic Automotive Electric Motors GmbH

(21) Appl. No.: 12/091,310

(22) PCT Filed: Oct. 27, 2006
(86) PCT No.: PCT/DE2006/001904

§ 371 Date: Apr. 24, 2008

(30) Foreign Application Priority Data
Oct. 28, 2005 (DE) 10 2005 052 865.1

(51) Int. Cl. B60K 1/00

(52) U.S. Cl. 180/65.1; 701/22; 903/902

(57) ABSTRACT

A motor vehicle, in particular an electric or hybrid vehicle, with an electric energy source and a control device assigned to said source, is intended to improve the degree of effectiveness and to extend the service life of the electric energy source in a vehicle of this type. For this purpose, according to the invention, a control device is provided which is designed to transmit control signals to the electric energy source which are generated from the basic data which characterises the operational activity to date.

### BACKGROUND OF THE INVENTION

The invention relates to a motor vehicle, in particular an electric or hybrid vehicle, with an electric energy source and a control device assigned to said source.

A hybrid motor vehicle is a motor vehicle which comprises the combination of different drive principles or different energy sources in order to drive the motor vehicle within one application. A differentiation is made between different hybridisation systems, such as micro-hybrid. Here, stop/start operation is possible. For this purpose, the system works with the existing on-board electrical system. In the micro-hybrid system, the combustion engine can be switched off, for example at a traffic light or in a traffic jam, and can automatically be re-started without any noticeable time delay when the motor vehicle starts to move again. With normal inner city stop-and-go traffic, a significant amount of fuel can be saved in this manner.

A further possibility is a mild hybrid when an alternative drive form is used only to support the main drive form, or a full hybrid when each of the drive forms provided are capable of acting autonomously. Different intermediate forms between these main forms are in existence, depending on requirements and usage.

One version of the hybrid motor vehicle is a combination of a combustion engine with one or more electric engines. The combustion engine with a hybrid drive can be operated to a very high degree of effectiveness. Any excess energy which is created is used via a generator for the electric charging of the battery. During acceleration, the combustion engine and the electric engine work together. When acceleration is achieved to an equal degree, a smaller combustion engine can therefore be provided. The reduction in size of the combustion engine here partly compensates for the additional weight of the hybrid aggregates.

A hybrid vehicle comprises at least one energy storage unit or one battery. The energy from this energy storage unit can be used to start the combustion engine, for the electric consumers in the motor vehicle and for acceleration procedures.

During braking and in boost mode, part of the braking energy is fed back into the battery, known as recuperation. In particular in urban traffic and when driving downhill, the energy recovered contributes towards reducing consumption. If no drive power is required, the combustion engine is also switched off. This is the case in boost mode, when at a standstill or when the battery is fully charged. A further advantage of this design is that no conventional engine starters are required, since the electric engine is capable of fulfilling this function.

A combustion engine supplies a serviceable torque only within a specific engine speed range. By contrast, the electric engine already provides the maximum torque when the motor vehicle starts to move, and reduces the torque when the engine speed increases. By means of a combination of the two engines, the more advantageous torque can in each case be used, and the motor vehicle can accelerate at approximately 10% to 20% more quickly.

Hybrid motor vehicles typically achieve a lower maximum speed by means of a less powerful combustion engine which in contrast to conventional motor vehicles no longer needs to be dimensioned for all driving states. This driving state, such as during fast driving on the motorway, is the only situation in which typically, high engine power is required over a longer period of time, which can only be provided by the combustion engine. During this operating phase, the hybrid mechanisms are only effective to a limited extent. The acceleration behaviour for which both engines are responsible is not affected by this.

Several versions of the design of a motor vehicle with a hybrid drive and the combination of a combustion engine with one or more electric engines are possible. In one possible version, the hybrid motor vehicle has a petrol and an electric engine which are linked via a planetary gear set to the drive axle. Operating states in which the combustion engine comprises only a low degree of effectiveness, such as when the motor vehicle starts to move or in urban traffic, are taken over by the electric motor to a very high degree of effectiveness. If necessary, the combustion engine can also be switched off completely. When driving with an even load, such as on the motorway or in walking mode, the petrol engine drives the motor vehicle alone, while the battery is simultaneously charged by the petrol engine via the generator. Under a heavier load, the motor vehicle is driven by both engines together. In engine braking mode, the energy can be recuperated. The energy saving over petrol driven motor vehicles of the same vehicle type is currently around 30% according to the prior art.

In another design, for example in order to increase drive performance in difficult terrain, the drive of the hybrid motor vehicle comprises alongside the petrol engine, two electric engines, one on the front axle and one on the rear axle.

A further design of the drive system provides that the electric engine does not sit on an axle, but is coupled between the engine and the gears on a drive train. As a result, a significant reduction is made in the technology required as opposed to the embodiments described above, which in turn leads to a lower power requirement and to lower production costs.

One technical advantage of the combination of a combustion engine with one or more electric engines as a drive is the faster activation of the drive situation stabilisation than with an ABS/ESP system with a standard hydraulic aggregate when the electric engines are linked to an ESP system, resulting in increased driving safety.

The object of the invention is to provide a motor vehicle of the type named above which improves the degree of effectiveness and the service life of the electric energy source in a motor vehicle of this type.

### SUMMARY OF THE INVENTION

This object is attained according to the invention in that the control device is designed to transmit control signals to the electric energy source which are generated from the basic data which characterises the driving activity to date.

The invention is based on the concept that a motor vehicle according to experience is driven in different operating states and with different requirements with regard to the power to be provided. In order to be able to cope with this situation, a motor vehicle is generally designed for a broad power spectrum, which is capable of both defensive and dynamic driving and the intermediate stages, as well as providing the power required in each case.

In a hybrid motor vehicle, the power for the electric engine is provided by an electric energy source. A defensive driving manner requires a relatively low power output from the electric energy source, and the power is also retrieved distributed over a specific time period. In contrast to this, with a dynamic driving manner, power peaks are created which are required to be achieved by the electric energy source.

In order to avoid having to provide the entire power spectrum for the driving behaviour of all users, a possibility should be found for providing the power in such a manner that it is also adjusted to the behaviour of the user in question. With a defensive driver, this can result in a reduction of the burden on the electric energy source, and an extension of the period of usage within a charge cycle, together with the service life of the electric energy source. For the dynamic user, the adjusted provision of energy and the potential use of power peaks can result in an increase in driving dynamic.

In order for the electric energy source to be able to deliver the power required for the respective driving mode, without initiating a power conditioned, premature ageing process, the electric energy source should be provided with corresponding basic data.

In order to evaluate the data which is adopted by the control device from the respective user of the motor vehicle, and to be able to convert it into basic data which characterises the driving activity to date, and in order to transmit to the control device the option of requesting energy as required from the electric energy source and to transmit to the energy source the data required to release power, an evaluation unit is advantageously provided in the motor vehicle which is connected to the control device via data lines which are designed accordingly.

So that the basic data which characterises the driving activity to date can be stored permanently, and newly acquired data can be converted into the basic data for the output of power as required, taking into account data which has already been acquired, a storage unit is provided which is advantageously connected to the control device.

The advantages gained with the invention are in particular that the adjustment of the power output of the electric energy source to a defensive driving manner leads to an increase in the service life of the electric energy source, and the adjustment to an offensive, dynamic driving manner leads to a higher driving dynamic and thus to broader acceptance of the hybrid drive on the target market.

### BRIEF DESCRIPTION OF THE DRAWINGS

An exemplary embodiment of the invention will now be described in greater detail with reference to a drawing, in which:

FIG. 1 shows a motor vehicle with an electric energy source in a cross section profile, and

FIG. 2 shows a schematic view of an electric energy source.

The same parts are assigned the same reference numerals in all figures.

### DETAILED DESCRIPTION OF THE DRAWINGS

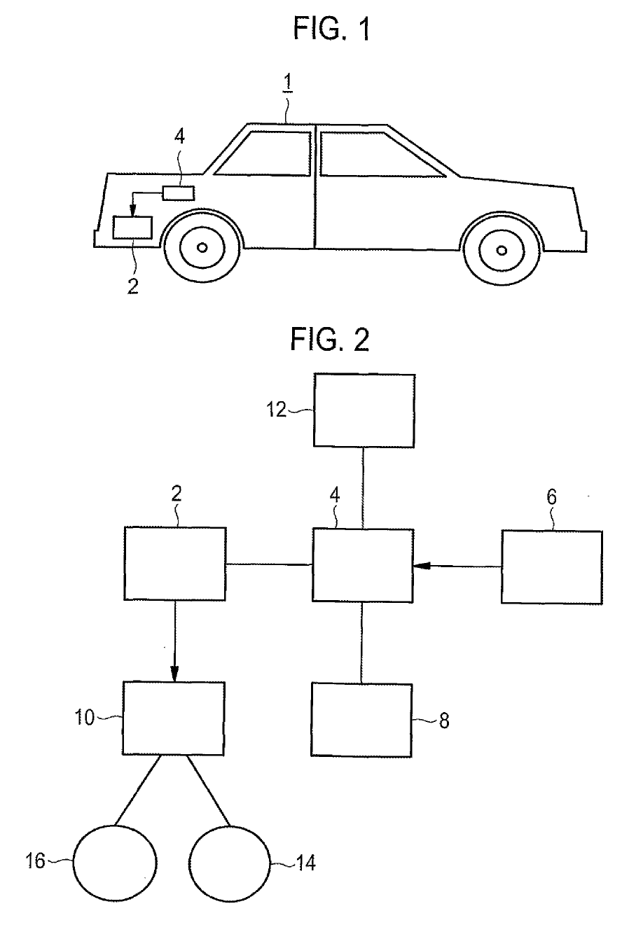

FIG. 1 shows a motor vehicle 1, in particular an electric or hybrid motor vehicle, which comprises an electric energy source 2 which is designed to secure the energy supply of the motor vehicle 1 in electric mode. This electric energy source 2 is assigned a control device 4 which routes the power output of the electric energy source 2 to the corresponding electric motor, not shown here, which drives the motor vehicle 1.

FIG. 2 shows a schematic view of the sequence of the routing of the power output depending on the parameters which influence the power output.

The control device 4 is connected on the data input side with a communication unit 6 which in drive mode of the motor vehicle 1 identifies the data which characterises the drive behaviour and which influences the power output of the electric energy source 2. The data range comprises different features which characterise the driving behaviour, which may include for example load states, engine speed, accelerator pedal position, shift points and steering movements.

This basic data which is assigned to driving behaviour is transmitted to the control device 4 and is stored in the storage unit 8 and/or assigned to basic data which has already been stored.

In the case of a defensive and restrained driving mode with low power peaks, the control device 4, on the basis of the basic data stored for this type of driving mode, requests a power output from the electric energy source 2 which runs in a flat curve when shown graphically. Due to a power request and power output of this type, the electric energy source 2 is protected, thus increasing service life.

The power output of the electric energy source 2 for a dynamic driving mode of the motor vehicle 1 essentially has a steeper curve, since the same level or a higher level of power is required to be provided within a shorter time in order to drive the electric motor 10 of the motor vehicle 1 than in defensive driving mode. As a result, a dynamic driving mode with higher power peaks is made possible, but the electric energy source 2 is subjected to greater load, which in turn can lead to a shorter service life as opposed to use in defensive driving mode.

This reduction in service life of the electric energy source 2 is designed to be avoided in that the monitoring of the power output and the storage of the basic data which characterises the power output enable a calculation of the anticipated service life and a comparison with data which has already been stored, and in the case of a power requirement which would mean exceeding the specified maximum values, the power output is restricted by the control device 4.

The control device 4 is furthermore connected to an evaluation unit 12. In the evaluation unit 12, the recorded data which characterises the operation sequence to date is evaluated, is assigned to basic and operational data which may already be present and which is stored in the storage unit 8, is modified if necessary; and the current basic data and the modified load data of the electric energy source 2 is stored in the storage unit 8 via the control device 4.

The power output of the electric energy source 2 to the electric engine 10 is completed as required on the one hand, by being adjusted to the driving behaviour and the power requirements of the respective user and to the respective drive mode, while on the other hand, the history and the load data of the electric energy source 2, which are stored in the storage unit 8, are taken into account. This data and the resulting values for the power output are reported by the control device 4 to the electric energy source 2.

The electric motor 10 either drives a drive axle 14 of the motor vehicle 1 directly, or is switched upstream in a gear set 16 which guides the power as required onto an axle, or distributes it over several axles.

### LIST OF REFERENCE NUMERALS

1 Motor vehicle
2 Electric energy source
4 Control device
6 Communication unit
8 Storage unit
10 Electric engine
12 Evaluation unit
14 Drive axle
16 Gear set

1-4. (canceled)

5. A motor vehicle comprising:
an electric energy source; and
a control device assigned to said source, which is designed to transmit control signals which are generated from basic data which characterises driving activity to date.

6. A motor vehicle according to claim 5, further comprising an evaluation unit which is connected to the control device in order to evaluate the basic data which characterises the operational activity to date.

7. A motor vehicle according claim 6, further comprising a storage unit for the permanent storage of the basic data which characterises the operational activity to date.

8. A method for operation a motor vehicle having an electric energy source and a control device assigned to said source, which is designed to transmit control signals which are generated from basic data which characterises driving activity to date, the method comprising:
controlling power output of an electric energy source depending on a result of basic data evaluation; and
restricting the power output of the electric energy source if a specified value TM069
for the power output of the electric energy source to date is reached or exceeded.
